(19) United States
(12) Patent Application Publication
(10) Pub. No.: US 2005/0276649 A1
(43) Pub. Date: Dec. 15, 2005

(54) Method of printing on thermal media

(75) Inventor: Byung-sun Min, Pyungtaek-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/145,942

(22) Filed: Jun. 7, 2005

(30) Foreign Application Priority Data
Jun. 10, 2004 (KR) 10-2004-0042502

(51) Int. Cl. B41J 2/32; B41J 3/60

(52) U.S. Cl. 400/120.16

(57) ABSTRACT

A system and method of printing on a thermal medium is provided. In the method, the thermal medium having first and second sides is fed to a print starting position and it is determined whether a print side of the thermal medium is the first side or the second side of the thermal medium. A corresponding color image according to the determined print side is then printed on the thermal medium, and a corresponding color image according to the opposite side of the determined print side is printed on the opposite side of the thermal medium, resulting in a correctly printed image.

### CROSS-REFERENCE TO RELATED APPLICATIONS

This application claims the benefit under 35 U.S.C. §119(a) of Korean Patent Application No. 10-2004-0042502, filed in the Korean Intellectual Property Office on Jun. 10, 2004, the entire disclosure of which is incorporated herein by reference.

### BACKGROUND OF THE INVENTION

1. Field of the Invention

The present invention relates to a method of printing on a thermal medium. More particularly, the present invention relates to a method of printing on a thermal medium, in which, a print side of a thermal medium is detected such that a thermal printer can correctly print a corresponding color image on the detected print side of the thermal medium.

2. Description of the Related Art

A thermal printer can be classified into two apparatus types, including a type using a heat-sensitive medium (that is, a thermal medium) and a type using a heat-sensitive ink ribbon. In the former type printer, a color image can be printed on the thermal medium by applying heat to the thermal medium. In the latter type printer, heat is applied to the ink-ribbon to transfer the ink of the ribbon to a print medium for printing an image on the print medium. The latter type printer requires a device for operating the ink ribbon, resulting in a complicated structure and higher manufacturing costs. Also, the latter type requires the periodical replacement of the ink ribbon, thereby increasing printing costs per page.

FIG. 1 is a sectional view of a conventional thermal medium. Referring to FIG. 1, the conventional thermal medium 10 includes a base sheet 11, a first side 10a, a second side 10b, and a reflective layer 13. The base sheet 11 may be transparent. Ink layers are formed on the first and second sides 10a and 10b, for example, yellow (Y) and magenta (M) layers on the first side 10a and a cyan (C) layer on the second side 10b. The reflective layer 13 reflects light such that an image can be shown on the first side 10a. One example of the thermal medium 10 is disclosed in U.S. Patent Application No. 2003-0125206, the entire disclosure of which is incorporated herein by reference.

The thermal printer using the thermal medium 10 includes a thermal print head (TPH) in which heating elements are arranged across the feeding direction of the thermal medium 10 at a right angle. To apply heat on both sides 10a and 10b of the thermal medium 10 with one TPH, the thermal medium 10 is fed to the TPH twice, first with the first side 10a facing the TPH and then with the second side 10b facing the TPH. After that, a color image can be seen on the first side 10a of the thermal medium 10.

FIG. 2 is a view showing a structure of a conventional thermal printer. Referring to FIG. 2, the conventional thermal printer includes a feed roller 2, an idle roller 5, a platen roller 3, and a TPH 4. The feed roller 2 conveys the thermal medium 10. The idle roller 5 urges the thermal medium 10 toward the feed roller 2 when the thermal medium 10 is passing through the feed roller 2 and idle roller 5. The platen roller 3 supports the thermal medium 10 against the TPH 4. The TPH 4 applies heat to the thermal medium 10 to form an image. The TPH 4 may be shifted or the thermal medium 10 may be turned over to apply heat on both sides 10a and 10b of the thermal medium 10.

Other types of printers can print an image on either side of a print medium without variation in print quality. However, the thermal printer is designed such that the TPH applies a different thermal profile on each side of the thermal medium 10 to form an image. Therefore, if a wrong side of the thermal medium 10 is printed, a wrong color image is printed on the thermal medium 10.

Accordingly, there is a need for a system and method of detecting the print side of the thermal medium to ensure correct printing.

### SUMMARY OF THE INVENTION

The present invention substantially solves the above and other problems, and provides a system and method of printing on a thermal medium for a thermal printer, in which, a print side of the thermal medium is detected prior to printing.

According to an aspect of the present invention, a method of printing on a thermal medium is provided and comprises the steps of feeding the thermal medium to a print starting position, wherein the thermal medium comprises first and second sides, determining whether a print side of the thermal medium is the first side or the second side of the thermal medium, printing a corresponding color image according to the determined print side, and printing a corresponding color image according to the opposite side of the determined print side.

The step of determining the print side may be carried out using a sensor for detecting a characteristic of the print side.

The printing of the corresponding color image according to the opposite side may further include the step of rotating a thermal print head (TPH) to face the opposite side of the thermal medium.

According to another aspect of the present invention, a method of printing on a thermal medium is provided and comprises the steps of feeding the thermal medium to a print starting position, wherein the thermal medium comprises first and second sides, printing a test pattern at a predetermined position of the thermal medium, determining whether a print side of the thermal medium is the first side or the second side of the thermal medium by detecting the test pattern, printing a corresponding color image according to the determined print side, and printing a corresponding color image according to the opposite side of the determined print side.

The printing test pattern can be provided by printing a specific color.

The step of determining the print side may be carried out using a sensor for detecting a characteristic of the specific color of the printed test pattern.

The thermal medium may comprise a print region, and a trim region located ahead of the print region along a medium feeding direction. The predetermined position for printing the test pattern is then placed in the trim region.

According to another aspect of the present invention, a method of printing on a thermal medium is provided and comprises the steps of feeding the thermal medium to a print starting position, wherein the thermal medium comprises a first side, a second side, and a test pattern determining whether a print side of the thermal medium is the first side or the second side of the thermal medium by detecting the test pattern, printing a corresponding color image according to the determined print side, and printing a corresponding color image according to the opposite side of the determined print side.

The step of determining the print side may include the steps of detecting at least one characteristic of the test pattern with a sensor, and comparing the detected characteristic with a set of predetermined characteristics of known test patterns.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view of a conventional thermal medium;

FIG. 2 is a view showing a structure of a conventional thermal printer;

FIG. 3 is a view showing a structure of a thermal printer where a method of printing on a thermal medium according to an embodiment of the present invention is employed;

FIG. 4 is a schematic plan view showing a thermal printer where a method of printing on a thermal medium according to an embodiment of the present invention is employed;

FIG. 5 is a schematic side view of a thermal printer depicted in FIG. 4;

FIG. 6 is a view of a thermal medium according to an embodiment of the present invention;

FIG. 7 is a flowchart showing a method of printing on a thermal medium according to a first embodiment of the present invention;

FIGS. 8A and 8B are views illustrating a method of printing on a thermal medium according to an embodiment of the present invention; and

FIG. 9 is a flowchart showing a method of printing on a thermal medium according to a second embodiment of the present invention.

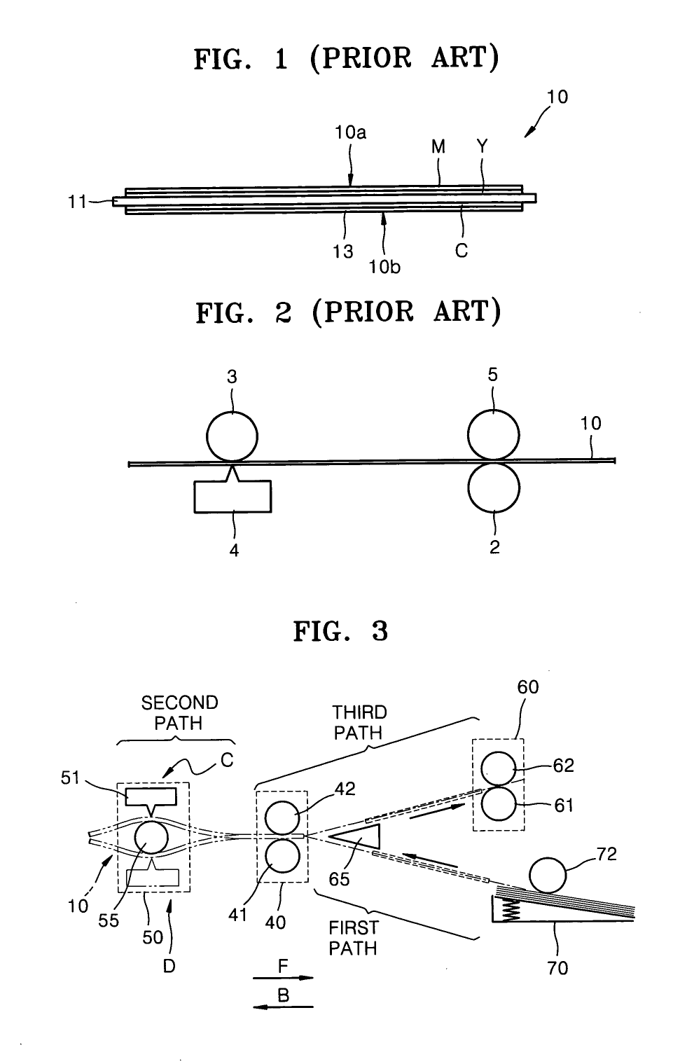

Throughout the drawings, like reference numerals will be understood to refer to like parts, components and structures.

### DETAILED DESCRIPTION OF THE EXEMPLARY EMBODIMENTS

The present invention will now be described in greater detail with reference to the accompanying drawings, in which, exemplary embodiments of the present invention are shown.

FIG. 3 is a view showing a structure of a thermal printer where a method of printing on a thermal medium according to an embodiment of the present invention is employed.

Referring to FIG. 3, a thermal printer comprises at least three paths, including a first path, a second path, and a third path. The thermal printer of FIG. 3 also comprises a medium cassette 70 for storing a thermal medium 10 to be printed, a pick-up roller 72 for picking up the media, a medium guide 65, a conveying part 40, an image forming unit 50, and a paper discharging unit 60. The conveying unit 40 comprises a feed roller 41 for conveying the thermal medium 10 and an idle roller 42 for urging the thermal medium 10 toward the feed roller 41. The image forming unit 50 comprises a thermal print head (TPH) 51 and a platen roller 55. The paper discharging unit 60 comprises an output roller 61 and an idle roller 62. In yet another embodiment of the present invention, one roller may be used for both the output roller 61 and pick-up roller 72.

A thermal medium 10 can be conveyed along the three paths. Specifically, the first path is connected with the second path at a point where the thermal medium 10 can be fed in a backwardly feeding direction that is indicated by the arrow (B), and then fed in a forwardly feeding direction that is indicated by the arrow (F), for printing. After the thermal medium 10 is printed on one side, the thermal medium 10 is conveyed from the second path to the third path and then conveyed again to the second path from the third path for printing on the other side. The thermal medium 10 is then conveyed from the second path to the third path and discharged out of the thermal printer.

The medium guide 65 is disposed between the first path and the third path for guiding the thermal medium 10 from the first path to the second path, and guiding the thermal medium 10 from the second path to the third path. Also, the medium guide 65 prevents the thermal medium 10 from proceeding to the first path from the second path. In addition, the medium guide 65 prevents the thermal medium 10 from being conveyed from the first path directly to the third path. Since the structure and design of the medium guide 65 is well known to those skilled in the art, a detailed description of the medium guide 65 will be omitted.

The image forming unit 50 is placed at the second path for printing an image on the thermal medium 10. Though the image printing may be accomplished through two or more operations, one printing operation is performed on each side of the thermal medium 10 for a total of two printing operations in the embodiment of the present invention. To print on both sides of the thermal medium 10, the positions of the TPH 51 may be rotated. For example, the TPH 51 is placed at a position (C) to print on a first side of the thermal medium 10, and is then rotated to a position (D) to print on a second side of the thermal medium 10. Preferably, the shifting between the position (C) and position (D) can be carried out by rotating the TPH 51 around the platen roller 55. To avoid an interference between the TPH 51 and the thermal medium 10 during the rotation of the TPH 51, the TPH 51 is rotated before the thermal medium 10 is fed from the first path to the second path, or before the thermal medium 10 of which one side is printed is conveyed again to the second path from the third path.

When the thermal medium 10 of which one side is printed is fed again to the TPH 51 in the backwardly feeding direction of arrow (B), the TPH 51 is shifted to the position (D) and prints an image on the other side of the thermal medium 10 as the thermal medium 10 is conveyed in the forwardly feeding direction of arrow (F) by the conveying unit 40. After that, the thermal medium 10 is output along the third path by the paper discharging unit 60.

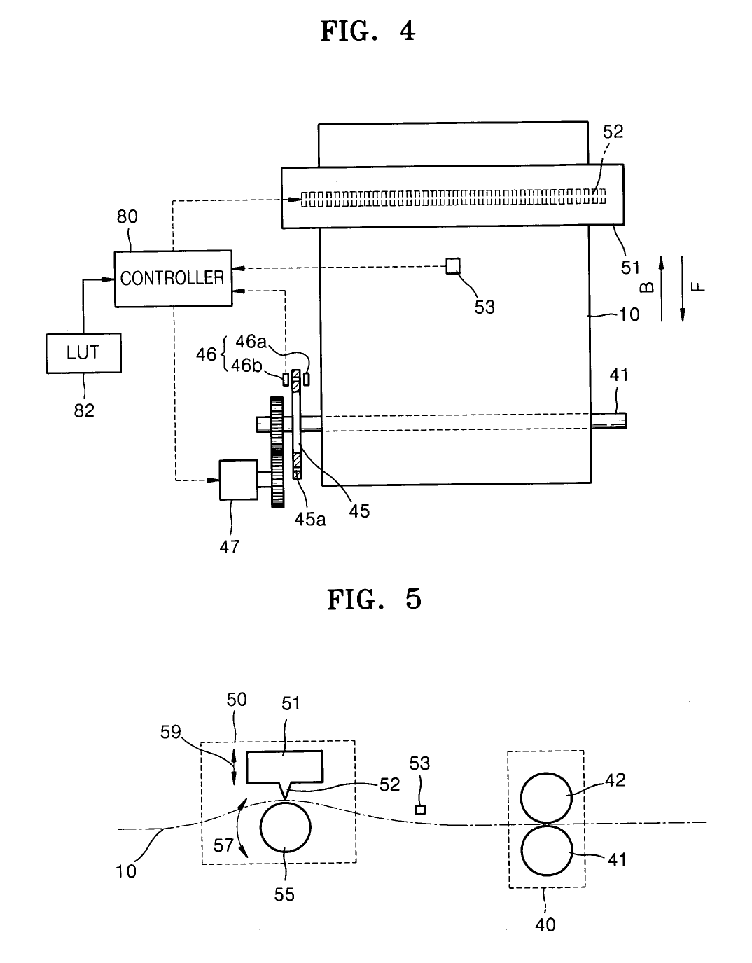

FIG. 4 is a schematic plan view showing an apparatus where a method of printing on a thermal medium 10 according to an embodiment of the present invention is employed, and FIG. 5 is a schematic side view of an apparatus depicted in FIG. 4.

Referring to FIGS. 4 and 5, the thermal medium 10 is fed between the TPH 51 and the platen roller 55 by the feed roller 41. Reference numeral 53 denotes an optical sensor for detecting the edge of the thermal medium 10 and a test pattern that can be formed on the thermal medium 10.

The TPH 51 comprises a plurality of heating elements 52 arranged across the feeding direction of the thermal medium 10 at a right angle. Though the heating elements 52 are arranged in a line in FIG. 4, the heating elements 52 may be arranged in any number of configurations, such as an arrangement of two or more lines of heating elements. Each of the heating elements 52 is heated for a predetermined time and reaches a desired temperature according to a voltage signal that is applied depending on the color image to be printed.

The feed roller 41 conveys the thermal medium 10 both in a backwardly feeding direction of arrow (B), and in a forwardly feeding direction of arrow (F). The feed roller 41 further comprises an encoder disk 45 at one end of the roller 41 axis. The encoder disk 45 includes slits 45a defined uniformly along an outer rim. A rotary encoder 46 is also provided at the outer rim of the encoder disk 45 and comprises a light-emitting element 46a and a light-receiving element 46b, between which, the outer rim of the encoder disk 45 is disposed. The light-emitting element 46a applies light to the outer rim of the encoder disk 45, and the light passed through the slits 45a causes the light-receiving element 46b to produce a pulse signal. The pulse signal is sent to a controller 80, and the controller 80 counts the pulse signals to measure a distance that the thermal medium 10 is fed by the feed roller 41. According to the measured distance, the controller 80 controls a motor 47 that drives the feed roller 41.

The thermal printer also comprises a rotating unit 57 and a vertical moving unit 59 that are simply denoted with double arrows in FIG. 5. After one side of the thermal medium 10 is printed, the rotating unit 57 rotates at least one of the TPH 51 and platen roller 55 to another position for printing on the other side of the thermal medium 10. The vertical moving unit 59 is used to shift the TPH 51 in a vertical direction with respect to the platen roller 55 and the thermal medium 10. For example, the vertical moving unit 59 can elevate the TPH 51 about 1 to 2 mm from the platen roller 55 such that the thermal medium 10 can be easily passed between the TPH 51 and platen roller 55 in the backwardly feeding direction of arrow (B).

The sensor 53 is provided to detect a test pattern that can be printed on the thermal medium 10, and to send an output signal to the controller 80.

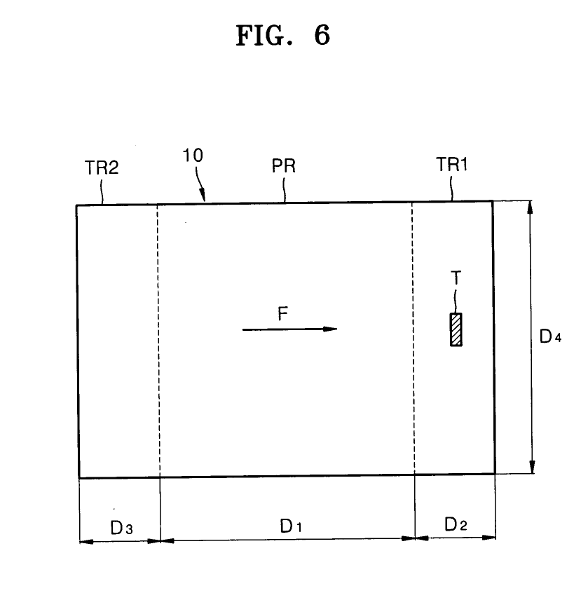

FIG. 6 is a view of a thermal medium according to an embodiment of the present invention. Referring to FIG. 6, the thermal medium 10 comprises a print region PR, a first trim region TR1, and a second trim region TR2. For example, the print region PR may have a transverse dimension D1 of 6 inches and a vertical dimension D4 of 4 inches. The first trim region TR1 may have a transverse dimension D2 of 1 inch, and the second trim region TR2 may have a transverse dimension D3 of ⅓ inch. An arrow (F) denotes a forwardly feeding direction of the thermal medium 10. That is, the thermal medium 10 is printed as it is fed in the forwardly feeding direction of arrow (F). Reference character (T) denotes a test pattern at the first trim region TR1. The shape of the test pattern (T) is not limited to the shape illustrated in FIG. 6, and can be comprised any number of shapes so long as the sensor 53 can detect the test pattern (T).

A method of printing on a thermal medium 10 in accordance with an embodiment of the present invention will now be described in greater detail with reference to the accompanying drawings, in which exemplary embodiments of the invention are shown.

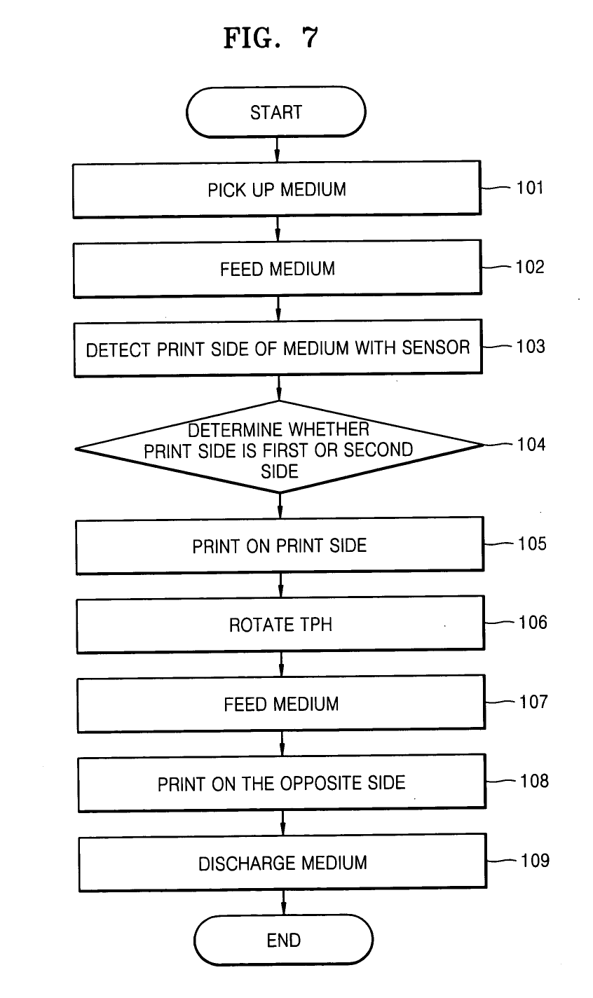

FIG. 7 is a flowchart showing a method of printing on a thermal medium 10 according to a first embodiment of the present invention. Referring to FIG. 7 and FIG. 3, in operation 101, the pick-up roller 72 picks up the thermal medium 10 from the medium cassette 70 and sends the thermal medium 10 along the first path upon a print command of a computer or host device connected to the thermal printer.

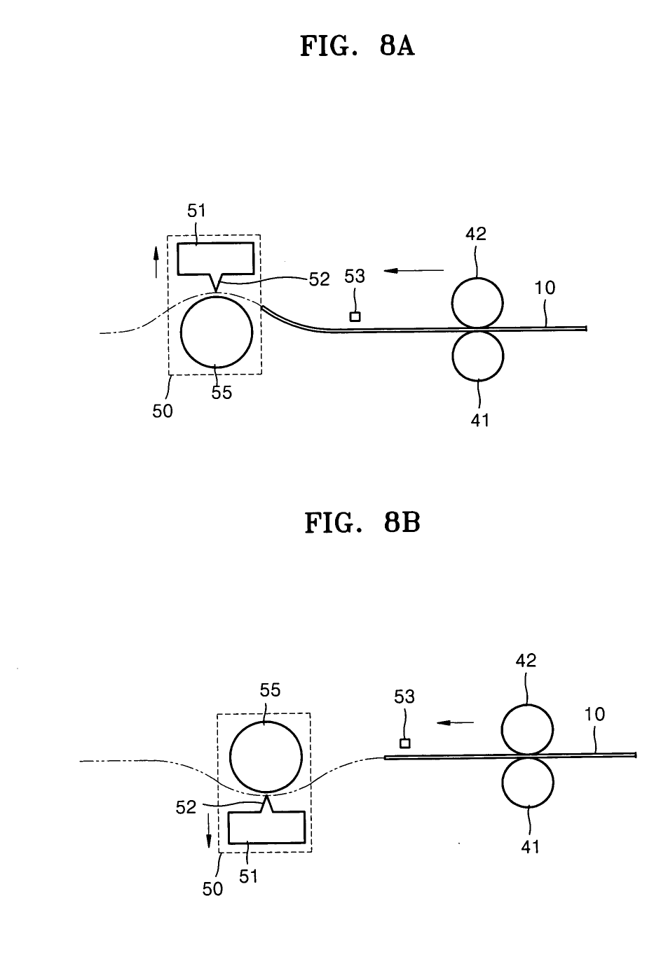

In operation 102, the medium guide 65 guides the thermal medium 10 toward the feed roller 41, and the feed roller 41 feeds the thermal medium 10 in the backwardly feeding direction of arrow (B) along the second path as more clearly shown in FIG. 8A. Herein, the TPH 51 is lifted to allow the thermal medium 10 to easily pass.

In operation 103, when a predetermined point at the first trim region TR1 reaches a point under the TPH 51, the backward feeding of the thermal medium 10 is suspended. The sensor 53 then detects a print side of the thermal medium 10 and sends an output signal to the controller 80. Herein, the term “print side of the thermal medium 10” or “print side” means a side that is facing the TPH 51 when the thermal medium 10 is fed for printing, and therefore, each side of the thermal medium 10 may be a print side because the thermal printer prints an image on each side of the thermal medium 10. The sensor 53 may be an optical sensor that includes a light emitter (not shown) for applying light to the thermal medium 10, and a light receiver (not shown) for receiving the reflected light from the thermal medium 10. The output signal of the sensor 53 may vary according to the print side of the thermal medium 10.

In operation 104, the controller 80 compares the output signal from the sensor 53 with values in a look up table (LUT) in order to determine whether the detected print side is a first side of the thermal medium 10 or a second side of the thermal medium 10.

In operation 105, the controller 80 sends image data corresponding to the detected print side to the TPH 51 for printing on the detected print side. For example, if the detected print side is the first side of the thermal medium 10, the controller 80 may send yellow and magenta image data to the TPH 51 for printing on the first side of the thermal medium 10.

In operation 106, after the printing on the detected print side, the image forming unit 50 is rotated to shift the TPH 51 to a position where the TPH 51 can print on the opposite side of the thermal medium 10 as shown in FIGS. 8A and 8B. Herein, before the rotation of the image forming part 50, the thermal medium 10 is further fed in the forwardly feeding direction of arrow (F) to prevent interference between the image forming part 50 and the thermal medium 10 during the rotation. The rotation of the image forming part 50, feeding of the thermal medium 10, and vertical movement of the TPH 51, can be achieved through control signals provided by the controller 80.

In operation 107, the TPH 51 is moved vertically away from the platen roller 55 to create a proper gap between the TPH 51 and platen roller 55, and the conveying unit 40 feeds the thermal medium 10 in the backwardly feeding direction of arrow (B) through the gap and along the second path.

In operation 108, after completing the backward feeding of the thermal medium 10, the TPH 51 is moved vertically toward the platen roller 55 and the opposite side of the thermal medium 10. The TPH 51 then prints an image corresponding to the opposite side while the thermal medium 10 is fed in the forwardly feeding direction of arrow (F) by the conveying unit 40. For example, if the opposite side is the second side of the thermal medium 10, the TPH 51 may print a cyan image on the opposite side.

In operation 109, after the opposite side of the thermal medium 10 is printed, the thermal medium 10 is conveyed toward the third path by the conveying unit 40, and is then discharged out of the thermal printer by the paper discharging unit 60.

In this exemplary embodiment of the present invention, the thermal printer shown in FIG. 3 is just one example of a thermal printer structure for use in implementing the method of the present invention. That is, in yet other embodiments of the present invention, a thermal printer which can simultaneously print on both sides of the thermal medium 10 and comprising two TPH, may be used. In this case, the rotation of the TPH 51, as noted in the operations of 106 and 107, may be omitted, and the printing operations of 105 and 108 may be simultaneously performed.

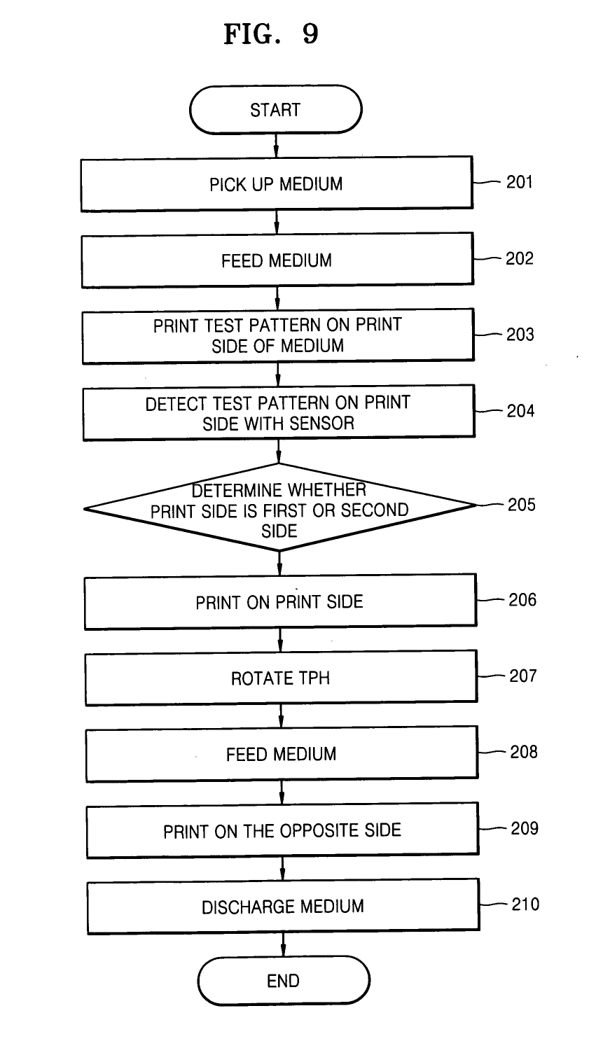

FIG. 9 is a flowchart showing a method of printing on a thermal medium 10 according to a second embodiment of the present invention. Referring to FIG. 9, in operation 201, the pick-up roller 72 picks up the thermal medium 10 from the medium cassette 70 and sends the thermal medium 10 along the first path upon a print command of a computer or host device connected to the thermal printer.

In operation 202, the medium guide 65 guides the thermal medium 10 toward the feed roller 41, and the feed roller 41 feeds the thermal medium 10 in the backwardly feeding direction of arrow (B) along the second path as more clearly shown in FIG. 8A.

In operation 203, when a first position of the first trim region TR1 reaches a point under the TPH 51, the backward feeding of the thermal medium 10 is suspended, and a test pattern (T) comprising a specific color (e.g., magenta) is printed at the first position as shown in FIG. 6. Herein, to determine whether the first trim region TR1 position is under the TPH 51, the sensor 53 and rotary encoder 46 may be used to detect an edge of the thermal medium 10 and measure the backwardly feeding distance of the thermal medium 10.

In operation 204, the thermal medium 10 is fed in the forwardly feeding direction by a reverse rotation of the feed roller 41, and the sensor 53 detects the test pattern (T) formed on the print side of the thermal medium 10 and sends an output signal to the controller 80.

In operation 205, the controller 80 compares the output signal with stored values in the LUT 82 in order to determine whether the detected print side is a first side of the thermal medium 10 or a second side of the thermal medium 10. For example, when a magenta test pattern (T) is printed at the first position in operation 203 and the output signal of the sensor 53 corresponds to a signal that is stored in the LUT 82 by detecting a magenta pattern formed on the first side, the controller 80 determines the print side is the first side.

In operation 206, the controller 80 sends image data corresponding to the detected print side to the TPH 51 for printing on the detected print side. For example, if the detected print side is the first side of the thermal medium 10, the controller 80 may send yellow and magenta image data to the TPH 51 for printing on the first side of the thermal medium 10.

In operation 207, after the printing on the detected print side, the image forming unit 50 is rotated to shift the TPH 51 to a position where the TPH 51 can print on the opposite side of the thermal medium 10 as shown in FIGS. 8A and 8B. Herein, before the rotation of the image forming part 50, the thermal medium 10 is further fed in the forwardly feeding direction of arrow (F) to prevent interference between the image forming part 50 and the thermal medium 10 during the rotation.

In operation 208, the TPH 51 is moved vertically away from the platen roller 55 to provide a proper gap between the TPH 51 and platen roller 55, and the conveying unit 40 feeds the thermal medium 10 in the backwardly feeding direction of arrow (B) through the gap and along the second path.

In operation 209, after completing the backward feeding of the thermal medium 10, the TPH 51 is moved vertically toward the platen roller 55 and the opposite side of the thermal medium 10, and then the TPH 51 prints an image corresponding to the opposite side while the thermal medium 10 is fed in the forwardly feeding direction of arrow (F) by the conveying unit 40. For example, if the opposite side is the second side of the thermal medium 10, the TPH 51 may print a cyan image on the opposite side.

In operation 210, after the opposite side of the thermal medium 10 is printed, the thermal medium 10 is conveyed toward the third path by the conveying unit 40, and is then discharged out of the thermal printer by the paper discharging unit 60.

In this exemplary embodiment of the present invention, the test pattern is printed on the thermal medium 10 in operation 203, however, the present invention is not limited to require this step. For example, in yet another embodiment of the present invention, a thermal medium 10 can be provided having a ready-made test pattern for use and therefore, operation 203 may be omitted.

As described above, the print side of the thermal medium is detected prior to printing, such that the thermal printer can properly print an image on both sides of the thermal medium even if the thermal medium is fed in an improperly reversed position.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of printing on a thermal medium, comprising:
feeding the thermal medium to a print starting position, wherein the thermal medium comprises first and second sides;
determining whether a print side of the thermal medium is the first side or the second side of the thermal medium;
printing a corresponding color image according to the determined print side; and
printing a corresponding color image according to the opposite side of the determined print side.

2. The method of claim 1, wherein the step of determining whether a print side of the thermal medium is the first side or the second side of the thermal medium is carried out using a sensor for detecting a characteristic of the print side.

3. The method of claim 1, wherein the step of printing a corresponding color image according to the opposite side further comprises the step of rotating a thermal print head (TPH) to face the opposite side of the thermal medium.

4. A method of printing on a thermal medium, comprising:
feeding the thermal medium to a print starting position, wherein the thermal medium comprises first and second sides;
printing a test pattern at a predetermined position of the thermal medium;
determining whether a print side of the thermal medium is the first side or the second side of the thermal medium by detecting the test pattern;
printing a corresponding color image according to the determined print side; and
printing a corresponding color image according to the opposite side of the determined print side.

5. The method of claim 4, wherein the step of printing the test pattern comprises the step of printing a specific color.

6. The method of claim 5, wherein the step of determining whether a print side of the thermal medium is the first side or the second side of the thermal medium is carried out using a sensor for detecting a characteristic of the specific color of the printed test pattern.

7. The method of claim 4, wherein the step of printing a corresponding color image according to the opposite side further comprises the step of rotating a thermal print head (TPH) to face the opposite side of the thermal medium.

8. The method of claim 4, wherein the thermal medium comprises:
a print region; and
a trim region located ahead of the print region along a medium feeding direction, wherein the predetermined position is placed in the trim region.

9. A method of printing on a thermal medium, comprising:
feeding the thermal medium to a print starting position, wherein the thermal medium comprises a first side, a second side, and a test pattern;
determining whether a print side of the thermal medium is the first side or the second side of the thermal medium by detecting the test pattern;
printing a corresponding color image according to the determined print side; and
printing a corresponding color image according to the opposite side of the determined print side.

10. The method of claim 9, wherein the step of determining whether a print side of the thermal medium is the first side or the second side of the thermal medium further comprises:
detecting a characteristic of the test pattern with a sensor; and
comparing the detected characteristic with a set of predetermined characteristics.

11. The method of claim 9, wherein the step of printing a corresponding color image according to the opposite side further comprises the step of rotating a thermal print head (TPH) to face the opposite side of the thermal medium.

12. The method of claim 2, wherein the sensor comprises an optical sensor.

13. The method of claim 6, wherein the sensor comprises an optical sensor.

14. The method of claim 10, wherein the sensor comprises an optical sensor.

15. An apparatus for controlling the printing of a thermal medium, comprising:
a sensor for applying light to a thermal medium and for receiving reflected light from the thermal medium to generate an output signal, wherein the output signal of the sensor can vary according to a print side of the thermal medium; and
a controller configured to compare the output signal from the sensor to detect whether a print side is a first side of the thermal medium or a second side of the thermal medium.

16. The apparatus of claim 15, further comprising:
a thermal print head (TPH), wherein the controller is further configured to send image data corresponding to the detected print side to the TPH for printing on the detected print side.

17. The apparatus of claim 16, wherein the controller is further configured to rotate the TPH to a position where the TPH can print on the opposite side of the thermal medium after printing on the detected print side.

18. The apparatus of claim 17, wherein the controller is further configured to feed the thermal medium to prevent interference during the rotation.

19. The apparatus of claim 17, wherein the controller is further configured to move the TPH vertically prior to and after the rotation.

20. The apparatus of claim 15, further comprising:
a look up table, wherein the controller is further configured to compare the output signal from the sensor with values in the look up table to detect the first and second print side.
